(19) United States
(12) Patent Application Publication
(10) Pub. No.: US 2013/0025209 A1
(43) Pub. Date: Jan. 31, 2013

(54) PIPELINE CLOSURE

(71) Applicants: Paul Lidster, Richmond (GB); Duncan Warriner, Richmond (GB)

(72) Inventors: Paul Lidster, Richmond (GB); Duncan Warriner, Richmond (GB)

(21) Appl. No.: 13/384,873

(22) PCT Filed: Jul. 2, 2010
(86) PCT No.: PCT/GB2010/051093

§ 371 Date: Aug. 13, 2012

(30) Foreign Application Priority Data
Jul. 21, 2009 (GB) 0912631.9

(51) Int. Cl. E05F 11/32

(52) U.S. Cl. 49/359; 49/506

(57) ABSTRACT

The invention provides a closure suitable for use on pipelines and pressure vessels, and which can resist high pressure but which can be opened quickly when the pressure differential across the closure has been reduced to zero. The closure comprises a door (3) which fits into an aperture of a hub (1) in a member (2) to be closed. A number of arcuate locking members or segment blocks (30) disposed around the periphery of the door for locking the door (3) to the hub (1). The locking members (30) are constrained by guide pins (34) to move along guide slots (40) in the door. A drive plate (101) is rotatably mounted on the door (3) and includes a plurality of drive slots (122) which engage with the guide pins (34). Rotation of the drive plate (101) relative to the door (3) causes the locking members (30) to move radially outwardly and circumferentially such that the locking members are moved from an unexpanded unlocked position to an expanded locking position in which the locking members (30) engage both the door (3) and the hub (1) thereby preventing opening of the door. A key member (82) is moved to a position between two adjacent locking members(30) to lock the closure. The closure is unlocked by removing the key member (82) and then rotating the drive plate (101) to move the locking members (30) back to the unexpanded unlocked position.

This invention relates to a closure suitable for use on pipelines and pressure vessels, and particularly to a closure which can resist high pressure but which can be opened quickly when the pipeline or pressure vessel pressure retained by the closure has been reduced to zero, and to a method of locking and unlocking such a closure.

Various types of pipeline and pressure vessel closure are known. One known type is the screwed closure, a two-piece design comprising an externally threaded hub and an internally threaded cap. It suffers from the disadvantage that it is slow to open and close and the threads can be difficult to align. The screw threads cannot be inspected when the closure is in the closed position.

A further known closure is the external clamp closure. This is a three-piece design comprising a hub, door and external locking clamps, and uses a pressure energised o-ring type seal. This type of closure is slow to open and close if fine threaded screws are used, and requires a high level of maintenance. The hinge arms are prone to sag.

Another known arrangement of closure is the locking band closure. This is a three piece design comprising a hub, a door and a split conical locking band actuated by an expander mechanism. A vent/bleeder screw and locking band segment prevent release of the band until pressure has been vented. This closure suffers from the disadvantage that the band is not well retained when the door is in the open position, with the result that the band can slip and distort on smaller lighter sizes if operated wrongly. On larger size closures the locking band is used as a carrier ring for the larger pressure-retaining segments, which may also lead to distortion and misalignment during operation. The primary function of the locking segment is to prevent the contraction of the main pressure-containing band and may not transfer load from the door into the hub. Consequently, in both the smaller and larger size closures of this type the locking band segment can be difficult to insert and remove.

Another known closure is the locking segment closure, a three piece design comprising a hub, a door and a number of segment locking blocks. Such a closure is described in EP 1054195A. A drive plate is rotated to move the segment blocks radially outwards to engage in a recess in the hub, thereby locking the door. Further rotation of the drive plate causes a lockout plate to engage the segment blocks and prevent them moving radially inwards. However the segment blocks have gaps between them when in the locked position, so that when the closure is subject to pressure load is not transferred from the door to the hub over the full circumference.

It is an object of the present invention to provide an improved closure which is quick and easy to open but which prevents opening of the closure under pressure and prevents retraction of the locking segment when the door is closed. It is a further object of the present invention to improve the distribution of force between the door and hub.

According to a first aspect of the present invention there is provided a closure comprising:

a door adapted to fit into an aperture in a member to be closed;

a plurality of arcuate locking members disposed around the periphery of the door for locking the door to said member, the locking members being constrained so as to permit movement of the locking members in at least a radial direction towards and away from the periphery of the door;

a key member; and

a drive member plate adapted to drive the locking members; such that rotation of the drive member relative to the door causes the locking members to move radially outwardly and at least some of the locking members to move circumferentially as well as radially outwardly such that the locking members are moved from an unexpanded unlocked position to an expanded locking position which permits the key member to be moved to a position between two adjacent locking members.

The drive member may comprise a drive plate. Rotation of the drive member relative to the door may also cause the locking members to move axially towards the door, urged by a cam surface on the drive plate.

Preferably the locking members are in mutual contact in the expanded locking position.

Preferably each locking member has at least one guide pin associated therewith. Each locking member may have two or more guide pins associated therewith.

The drive member may comprise a plurality of drive slots each engaging a respective guide pin associated with one of said locking members. The drive slots may be through slots or channels.

The door may include a plurality of guide slots each engaging one of said guide pins. The guide slots may be through slots or channels, and may be provided on a plate secured to the door, or directly on the door.

Rotation of the drive member relative to the door in a first locking direction may cause the guide pins to move radially outwardly and at least some of the guide pins to move circumferentially as well as radially outwardly such that the locking members are moved to an expanded locking position which permits the key member to be moved to a position between two adjacent locking members. Rotation of the drive plate relative to the door may cause the drive slots of the drive plate to urge the guide pins to travel along the guide slots of the door.

Preferably the aperture comprises a substantially cylindrical bore. Preferably the cylindrical bore has a locking recess. The recess may have a planar bearing surface adapted to seal against a corresponding bearing surface on the door. The recess may have an angled wedge surface opposed to the bearing surface.

The locking members may be provided with a corresponding angled surface adapted to engage the angled wedge surface.

The drive member may be rotatably mounted to the door on an axis of rotation. Preferably each drive slot has a first arcuate portion whose spacing from the axis of rotation is substantially constant, and a second offset portion whose spacing from the axis of rotation decreases with distance from the first portion. Preferably the drive slots are provided with first arcuate portions of different length, adapted to drive the locking members through corresponding different amounts of circumferential displacement when the locking members are moved from the unexpanded unlocked position to the expanded locking position.

In one embodiment each arcuate locking member has two guide pins associated therewith, each guide pin being adapted to engage a respective drive slot in the drive plate. Preferably the guide pins are each adapted to also engage a respective guide slot in the door.

Preferably the guide slots in the door are arranged such that their longitudinal axis is at an angle of inclination to the radial direction. Preferably the angle of inclination varies according to the circumferential position of the guide slot. Preferably the angle varies between 0° and 90°.

The key member is preferably arcuate. Preferably the key member has a cross-sectional shape similar to that of the locking members.

The key member may be slidably mounted to the door. Preferably there is provided a lever means adapted to permit the key member to be moved radially outwardly from a first unengaged position to a second engaged position in which the key member is engaged between two locking members to form a substantially continuous ring with the locking members.

The closure may be provided with additional locking means comprising an externally threaded vent plug. Preferably the door is provided with an internally threaded vent aperture adapted to receive the vent plug. Preferably the vent plug is connected to move with the key member, and may be retained on the key member. Preferably the vent plug can only be received in the internally threaded vent aperture when the key member is in the engaged position. This prevents the key member being removed from its engaged position until the vent plug has been unthreaded from the vent aperture.

According to a second aspect of the present invention there is provided a method of locking a closure comprising a door adapted to fit into an aperture in a member to be closed, the method comprising:

rotating a drive member rotatably mounted on the door to thereby urge a plurality of arcuate locking members disposed around a periphery of the door to move radially outwards and circumferentially towards each other, such that the locking members are moved from an unexpanded unlocked position to an expanded locking position in which the locking members are in mutual contact with a gap between two adjacent locking members; and

moving a key member into the gap between the two adjacent locking members to thereby prevent the locking members from moving radially inwards;

such that in the expanded position the locking members engage both the door and the aperture thereby preventing opening of the door.

According to a third aspect of the present invention there is provided a method of unlocking a closure comprising a door adapted to fit into an aperture in a member to be closed, the method comprising:

moving a key member from between two adjacent locking members of a plurality of locking members disposed around a periphery of the door to thereby permit the locking members to move radially inwards;

rotating a drive member rotatably mounted on the door to thereby urge the plurality of arcuate locking members disposed around the periphery of the door to move radially inwards and circumferentially away from each other, such that the locking members are moved from an expanded locking position to an unexpanded unlocked position in which the locking members are in mutual contact with a gap between two adjacent locking members; and

moving a key member into the gap between the two adjacent locking members to thereby prevent the locking members from moving radially inwards;

such that in moving to the unexpanded position the locking members come out of engagement between the door and the aperture thereby permitting opening of the door.

### An embodiment of the invention will now be described, by way of example only, with reference to the accompanying figures, where:

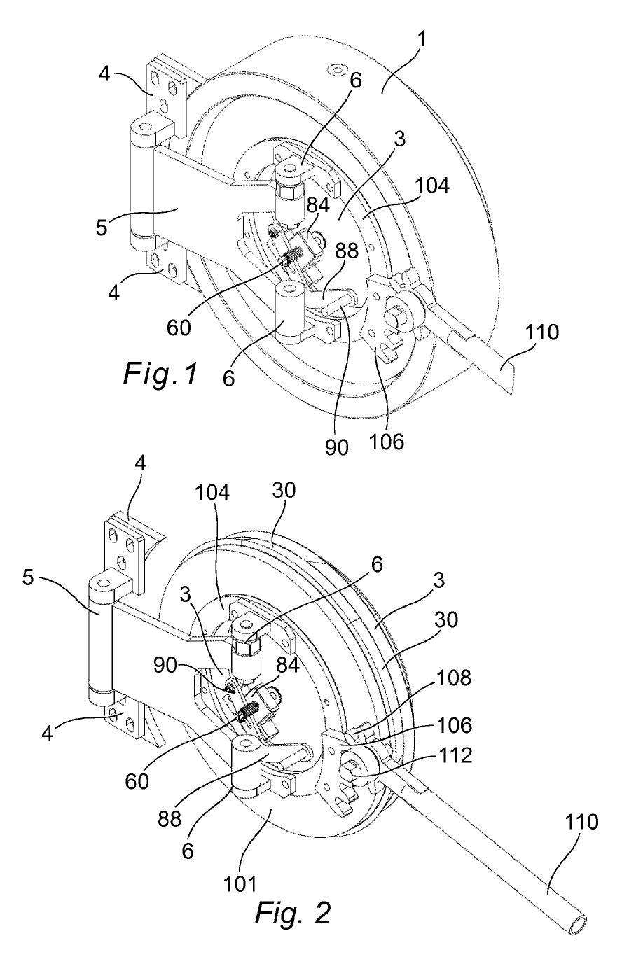

FIG. 1 shows a closure according to the present invention;

FIG. 2 shows the closure of FIG. 1 with the hub omitted for clarity;

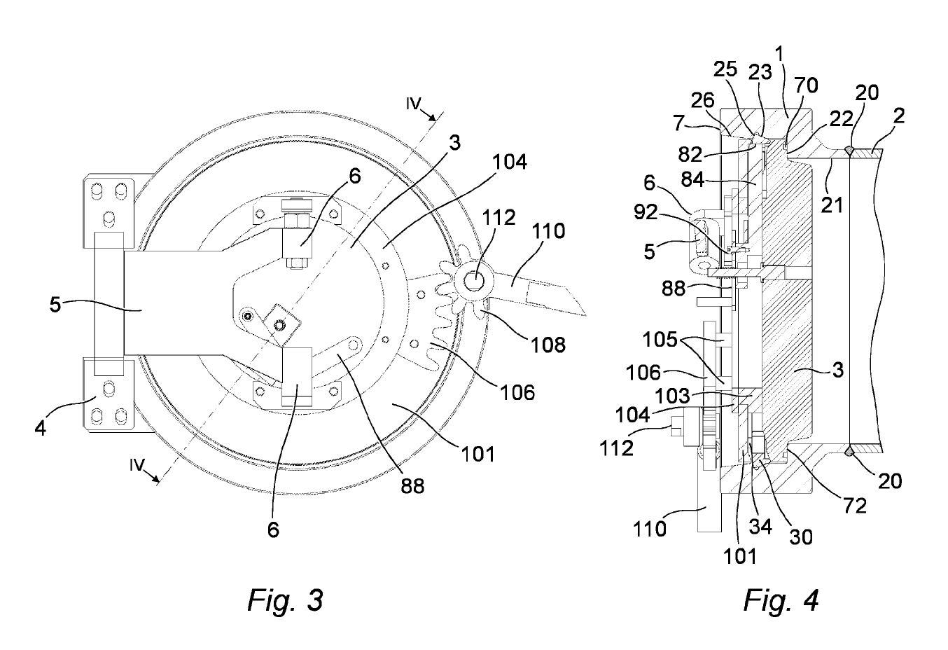

FIG. 3 is a front elevation on the closure of FIG. 1;

FIG. 4 is a sectional view on line IV-IV of FIG. 3;

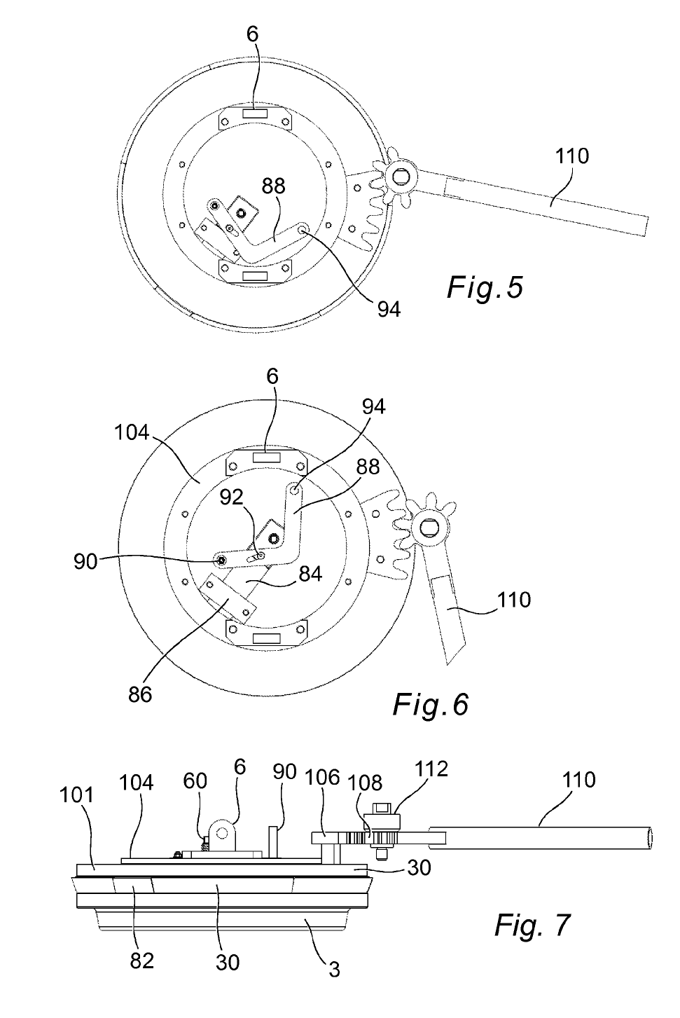

FIG. 5 is a front elevation on the closure of FIG. 1 in the locking position;

FIG. 6 is a front elevation on the closure of FIG. 1 in the unlocked position;

FIG. 7 is a side elevation on the closure of FIG. 1 in the unlocked position;

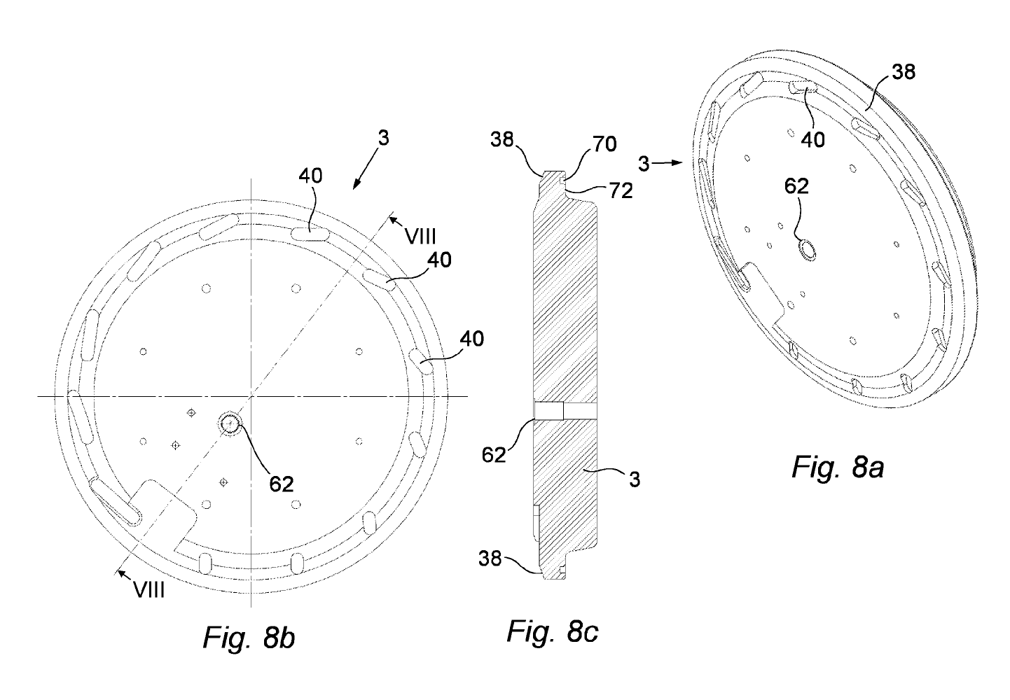

FIGS. 8a, 8b, 8c show a perspective view, a front elevation and a sectional view on line VIII-VIII respectively of the door of the closure of FIG. 1;

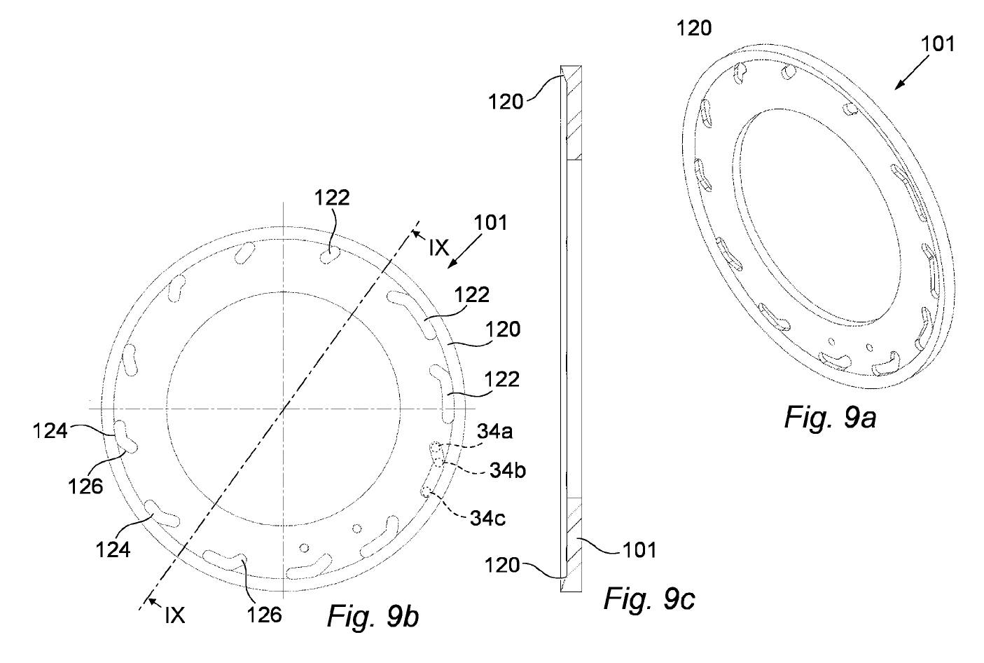

FIGS. 9a, 9b, 9c show a perspective view, a front elevation and a sectional view on line IX-IX respectively of the drive plate of the closure of FIG. 1;

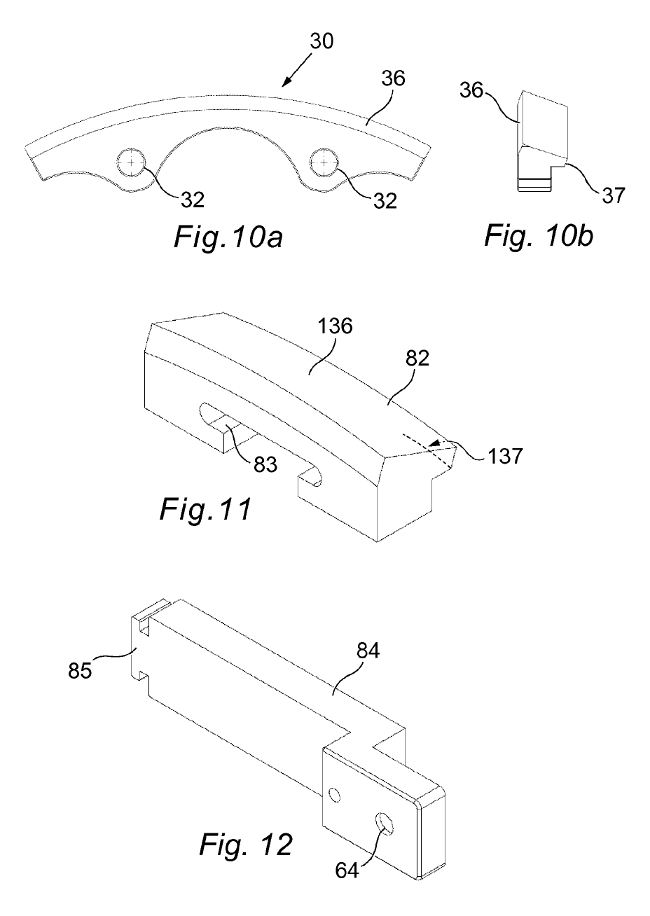

FIGS. 10a and 10b show a a front elevation and an end elevation respectively of a locking member or segment block of the closure of FIG. 1;

FIG. 11 shows the key segment of the key member of the closure of FIG. 1;

FIG. 12 shows the key slider of the key member of the closure of FIG. 1;

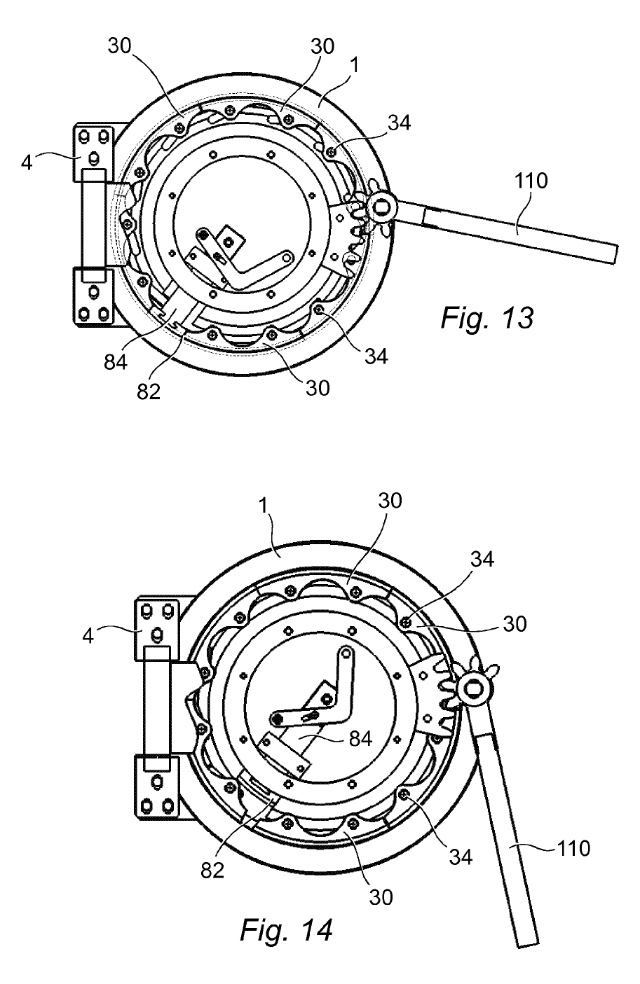

FIG. 13 is an elevation on the closure of FIG. 1 in the locking position with the guide plate removed for clarity;

FIG. 14 is an elevation on the closure of FIG. 1 in the unlocked position with the guide plate removed for clarity;

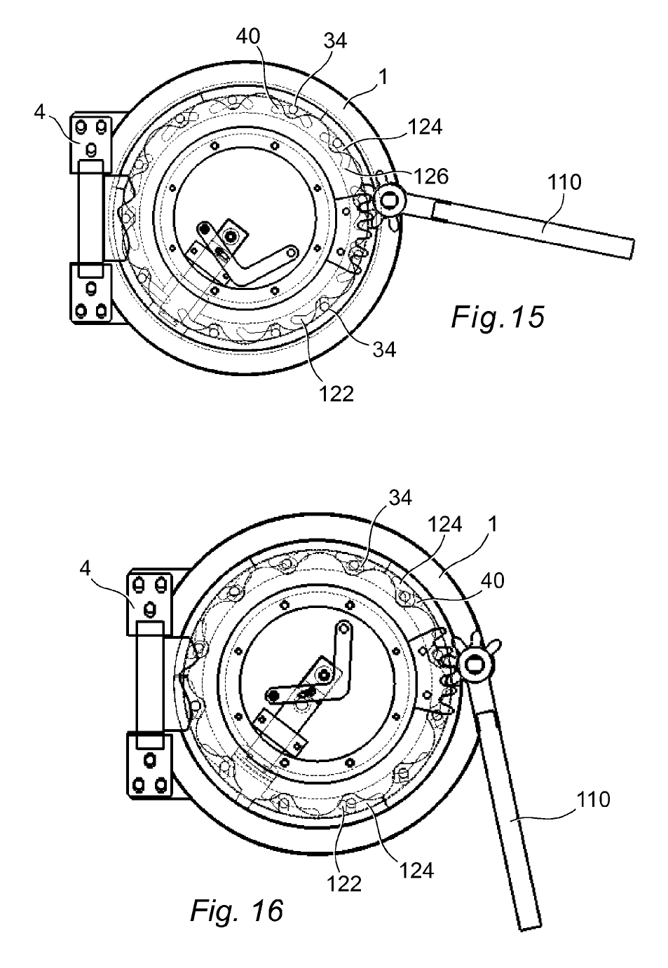

FIG. 15 is a schematic view of the closure of FIG. 1 in the locking position showing the relationship between the guide slots and drive slots;

FIG. 16 is a schematic view of the closure of FIG. 1 in the unlocked position showing the relationship between the guide slots and drive slots;

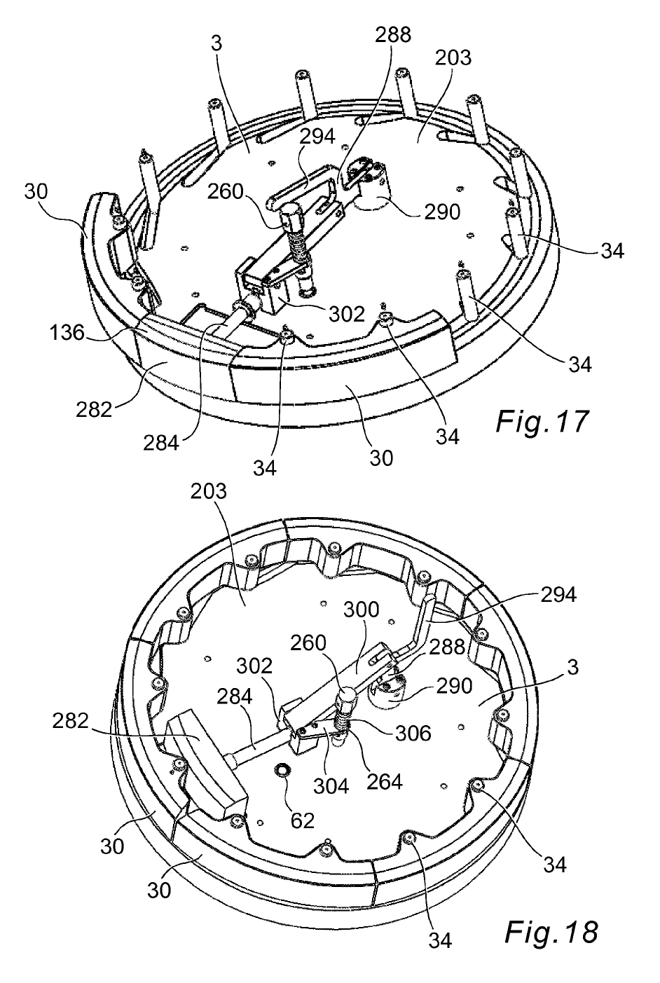

FIG. 17 shows a partial view of a door of another closure according to the invention in the locking position; and

FIG. 18 shows a partial view of the door of the closure of FIG. 17 in the unlocked position.

Referring to FIGS. 1 to 16 there is shown an embodiment of a closure according to the invention. The closure may be used with high pressure, large diameter pipelines of the type used in the oil and gas industry, or with pressure vessels.

A hub 1 is adapted to be welded within the opening of a member, for example a pipeline or pressure vessel 2. The hub 1 includes an aperture, which may be closed to thereby close the member 2. A circular door 3 is mounted on a hinge assembly 4 secured to the hub 1 by an arm 5 and two pivot brackets 6 secured to the door 3, allowing the door 3 to be swung away from the hub 1 by rotation about the hinge assembly 4 and to be rotated about the pivot brackets 6 so that the mating surfaces of the hub 1 and door 3 are parallel. The two pivot brackets 6 allow the door 3 to be moved into and out of the closed position substantially in an axial direction perpendicular to the plane of the door 3.

The hub 1 is substantially in the shape of a hollow circular cylinder. The outer surface of the cylinder tapers towards the rear face, where a bevelled edge permits the formation of a butt weld 20 with the adjacent pipe 2. The inner surface of the cylinder has a first portion 21 adjacent to the rear face which has a diameter equal to that of the adjacent pipe 2. Next to the first portion 21 is a step portion 22 forming a perpendicular sealing surface which is adapted to engage with a sealing surface on the door 3. Adjacent to the step portion 22 is a tapered recess portion 23 adapted to accommodate the segment blocks 30, described later.

At the front end of the tapered recessed portion 23 is an angled return shoulder 25, which is adapted to fit against a corresponding angled surface on the segment blocks 30, described later. A further tapered portion 26 of the inner surface extends from the shoulder 25 to the front face 7 of the hub 1. The tapered portion 26 assists in guiding the door to a central position as the door is closed.

Arranged on the front face of the door 3 is a drive plate retainer 103 which rotatably supports a drive member 101 in the form of a drive plate. Although the drive member 101 herein described has a plate shape, it is to be understood that the drive member be of a different shape, for example a ring or block. A retainer cover plate 104 is fixed to the retainer 103 to retain the drive plate 101. Fixed to the drive plate 101 is a ratchet plate 106 which engages with a toothed gear 108 provided on a handle 110. The ratchet plate 106 is fixed to the drive plate 101 by any suitable means.

In the illustrated example it is fixed by two shear legs 105. The handle is pivotably supported on a pivot axis 112 secured to the hub 1. Rotation of the handle 110 causes rotation of the drive plate 101 through the meshing of the ratchet plate 106 and the toothed gear 108 on the handle 110. The handle 110 can instead be pivotably supported on the door 3 instead of the hub 1, which allows the drive plate 101 to be operated when the door 3 is not mounted on the hub 1, for example during servicing.

Arranged between the drive plate 101 and the door are a number of arcuate segment blocks 30, also referred to as locking members, shown in detail in FIG. 10. Each segment block 30 extends around a portion of the perimeter of the door 3, and has two apertures 32 adapted to house guide pins 34. The segment block 30 has an angled bearing surface 36 which in use bears against the angled return shoulder 25 of the hub 3. On the opposite side of the segment block 30 is a door engaging surface 37 which in use bears against a corresponding surface 38 on the door 3.

The drive plate 101 is seen best in FIG. 9. It is annulus shaped to fit around the drive plate retainer 103 and includes a bevelled flange 120 at its outer circumference, The bevelled flange 120 serves to urge the segment blocks towards the door 3 as they are moved outwards, as explained below. The drive plate 101 has a number of drive slots 122, formed as through slots arranged adjacent to the flange 20. It should be noted that the view in FIG. 9b is a view looking away from the door, and is in the opposite sense of the view of the door itself in FIG. 8b.

Each segment block is held between the door 3 and the drive plate 101 by two guide pins 34, which each pass through a corresponding aperture 32 in the segment block and engage with a drive slot 122 in the drive plate 101 and a guide slot 40 in the door 3. The guide slots 40 in the door are best seen in FIG. 8, and are formed as channels in the front face of the door 3. They are arranged inside the perimeter of the door 3. In the illustrated embodiment there are six segment blocks 30 and two guide pins 34 per segment block 30, so that there are twelve guide slots 40 in the door 3 and twelve drive slots 122 in the drive plate 101. However the number of segment blocks and pins, hence the number of slots, can be varied. One end of the guide pin 34 engages with the guide slot 40, while the other end engages with the drive slot 122.

The segment blocks 30 are moved together by a single movement of the handle 110 from the unlocked position of FIG. 14 to the locking position of FIG. 13. Rotation of the handle 110 causes rotation of the drive plate 101. Rotation of the drive plate causes the drive slots 122 to rotate relative to the guide slots 40. Each drive slot 122 has a first arcuate portion 124 whose spacing from the axis of rotation of the drive plate 101 is substantially constant, and a second offset portion 126 whose spacing from the axis of rotation decreases with distance from the first portion. The length of the second offset portion 126 is substantially constant in each drive slot 122, but the first arcuate portions 124 are of different length.

When the closure is in the unlocked position, the segment blocks 30 are in an unexpanded arrangement, and are in contact with each other, or are separated only by small gaps, thereby forming a substantially unbroken ring of a first smaller diameter, seen most clearly in FIG. 14. The drive pins 34 are in the position 34a shown in FIG. 9b. When the drive plate 101 is rotated in an anti-clockwise direction when viewed in FIG. 9b, that is a clockwise direction when viewed in FIGS. 15 and 16, the drive pins cannot rotate with the drive plate because they are engaged with the fixed guide slots 40 in the door 3, so they are instead urged outwards by the cam effect of the second offset portions 126 of the drive slots 122 until they reach the position 34b. This movement of the pins results in radially outward movement of the segment blocks coupled with a varying degree of circumferential movement, depending on the angle of inclination of the fixed guide slots 40 on the door 3. When they reach this position the segment blocks 30 are in an expanded arrangement, but are not in contact with each other, so they form a broken ring of a second diameter larger than the first diameter. Further rotation of the drive plate results in varying degrees of circumferential movement only of the segment blocks 30, which does not commence until the drive pin 34 reaches the position 36c. Hence the shorter the length of the first arcuate portion 124 of the drive slot, the greater the circumferential displacement of the drive pin 34 and the segment block 30. At the end of the rotation of the drive plate 101 the segment blocks 30 are in contact with each other, so they form a ring of a second diameter larger than the first diameter with a single gap, best seen in FIG. 13.

It is thus clear that the different lengths of the first arcuate portion 124 of the drive slots 122, combined with the different lengths and angles of the guide slots 40 in the door 3, result in the segment blocks 30 being driven through corresponding different amounts of circumferential displacement when the segment blocks 30 are moved from the unexpanded unlocked position to the expanded locking position. This is most clearly seen in FIGS. 15 and 16, in which the relationship between the drive slots 122, guide slots 40 and drive pins 34 can be seen in the locking position in FIG. 15 and in the unlocked position in FIG. 16.

In the expanded locking position each segment block 35 is thus moved radially outwards to a locking position in which it partially overhangs the outer perimeter 41 of the door.

When the door 3 is closed, such that the seal 70 in the rear bearing surface 72 of the door bears against the step portion 22 of the hub 1, and the drive plate is rotated to the locking position, each segment block 35 is moved radially outwards to an expanded locking position in which it locates within the recess 23 in the hub 1. As the segment block 30 is moved radially outwards the tapered front surface 34 of the segment block 30 locates against the tapered surface 25 of the hub 1. The segment block becomes elastically deformed under the wedge action of the corresponding tapered surfaces 25 and 34, and the effect is to push the door 3 tighter against the step portion 22 of the hub 1

Provided on the front of the door 3 is a key member or key segment 82 mounted on a key slider 84. The key segment 82 has an angled bearing surface 136 similar to the bearing surface 36 of the segment blocks 30, which in use bears against the angled return shoulder 25 of the hub 3. On the opposite side of the key segment 82 is a door engaging surface 137 which in use bears against a corresponding surface 38 on the door 3. The key segment 82 has a groove 83 in which a tongue 85 on the key slider 84 is engaged, so as to permit sliding movement only in a direction perpendicular to the face of the door 3. This enables the key segment to move axially relative to the key slider 84 to provide a secure engagement between the door 3 and hub 1, without deforming the key slider 84.

The key member 82 is fixed to the door by a key slider guide 86 which restrains the key member 82 in all degrees of freedom except a radial sliding movement. A lever means in the form of a key lever 88 is pivotally mounted to the front of the door 3 by a pivot mounting 90. The key lever 88 has a slot through which it is linked by a key pin 92 to the key slider 84, such that rotation of the key lever 88 by pulling on a handle 94 provided on the end of the key lever 88 in a clockwise direction (as shown in FIG. 6) results in sliding movement of the key member radially outwardly from a first unengaged position shown in FIGS. 6 and 14 to a second engaged position, so that the key member adopts the engaged position shown in FIGS. 5 and 13, in which the key segment 82 fills the gap formed between the segment blocks 30 in the expanded position at the end of the rotation of the drive plate 101, when the segment blocks 30 are in contact with each other.

In this configuration the key segment and segment blocks form a continuous ring so that the segment blocks 30 cannot be displaced radially and the closure is thus locked.

As an option, the closure of the present invention can incorporate a vent plug, for example a threaded vent pin 60, which prevents the door 3 being opened while there is a large pressure difference across the closure. The vent pin 60 is loosely but irremovably connected to the key slider 84 through an aperture 64 in the key slider 84. When the key member 82 is in the locked position the vent pin 60 is aligned with a threaded aperture 62 in the door 3. The vent pin 60 can only be screwed into the aperture 62 to seal the door 3 when the key member 82 is in the locked position. In order to move the key member to the unlocked position and thus to enable the closure to be opened, the vent pin 60 must first be removed from the aperture 62. Optionally the vent pin 60 may be spring mounted to the key slider 34, so that it is biased away clear of the door 3 when it is unscrewed.

FIGS. 17 and 18 show an alternative arrangement for operating the key member 282. The key member 282 is connected in the same way as described with reference to FIGS. 1 to 16 to a key slider 284, which can be slidably mounted in a sleeve (not shown) secured to the door 203. The key segment 282 has the same shape as the key segment 82 described with reference to FIGS. 1 to 16.

The key slider 284 is attached to a slider block 302, which is pivotally connected to a cam arm 300, which itself is pivotally connected to a lever means, comprising a key lever 288 pivotally mounted to the front of the door 3 by a lever mounting block 290. The key lever 288 is arranged so that it acts with the cam arm 300 to provide a significant mechanical advantage during the last stage of movement of the key member 282 into the locking position shown in FIG. 17.

Rotation of the key lever 288 by moving a handle 294 provided on the key lever 288 from left to right as shown in FIGS. 17 and 18 results in sliding movement of the key member 282 radially outwardly from a first unengaged position shown in FIG. 18 to a second engaged position shown in FIG. 17, in which the key segment 282 fills the gap formed between the segment blocks 30 in the expanded position.

Fixed to the slider block 302 is a valve support arm 304 which has an aperture 264 in which a vent pin 260 is irremovably connected to the valve support arm 304. A spring 306 biases the vent pin 260 away from the door 3. When the key member 282 is in the locked position the vent pin 260 is aligned with the threaded aperture 62 in the door 3. The vent pin 260 can only be screwed into the aperture 62 to seal the door 3 when the key member 282 is in the locked position. In order to move the key member to the unlocked position and thus to enable the closure to be opened, the vent pin 260 must first be removed from the aperture 62. The spring 306 positively lifts the vent pin clear of the door when the threads are disengaged.

The closure of the present invention offers a number of advantages. The closure door 3 is secured in place by the independently operated segment blocks 30. If there is any residual pressure behind the closure door the force exerted on the door and hence on the segments 35 makes it difficult to disengage the segments, thus acting as a safety warning of possible trapped pressure or other problems.

In the locked position the key segment forms a complete hoop with the other segment blocks, so that they are prevented from moving inwards by the compressive hoop forces between adjacent segments. The key slider, which is secured in place by the vent/bleeder screw 60, ensures that no locking segment blocks 30 can be withdrawn until the vent/bleeder screw 60 has been removed and hence the vessel vented of all pressure.

The unlocking and opening of the closure door takes place in the following fashion.

(a) Ensure that the vessel isolation valve (not shown) has been fully closed.

(b) Ensure that the vessel 2 has been fully drained and vented and isolated from any other pressure source.

(c) Unscrew the vent plug 60 until it is clear of the door 3, but still retained on the key slider 84. If on loosening a 1/4 turn pressure escapes, retighten and investigate.

(d) Pull up the key handle 94 to raise the key lever 88 and slide the key member 82 from the engaged position towards the middle of the door.

(e) Attach and push down the handle 110 to rotate the drive plate 101. The segment blocks 30 are urged to move circumferentially away from each other and radially inwards by the action of the guide pins 34 in the guide slots 40 and drive slots 122. The segment blocks 30 are thus released from the closure hub recess 23 and retracted onto the closure door front.

(f) Remove and store the handle 110. The door 3 can now be swung open.

Locking and closing of the door of the closure of the invention is accomplished in the following manner:

(a) Prior to closing ensure the door seal 70 is in good condition with no cuts or abrasions, check that the hub seal face 22, door seal face 72, hub tapered recess 23 and door seal 70 are clean and free from debris. Lightly coat the seal and mating faces with silicon grease for protection against corrosion. Ensure all locking segments 30 are fully retracted into the door area.

(b) Swing the door 3 around to the hub aperture 1 and align the door so that the door 3 enters squarely into the hub 1.

(c) Pull up the handle 110 to rotate the drive plate 101. The segment blocks 30 are urged to move radially outwards and circumferentially toward each other by the action of the guide pins 34 in the guide slots 40 and drive slots 122. The segment blocks 30 are thus urged into the closure hub recess 23. The segment blocks are free to move axially on the guide pins 34, and are urged towards the door 3 by the tapered flange 120 on the drive plate 101. The segment blocks 30 thus move out in three directions, radially, circumferentially and tangentially to the conical face of the door. This movement is staged by the arrangement of drive slots 122 and guide slots 40 in such a manner that each segment follows the previous segment providing a smooth and gradual transition into the hub profile, rather than a full face contact which would be prone to jamming. When the handle 110 can be rotated no more, because the guide pins 34 have reached the full extent of their travel, the segment blocks 130 are in their expanded position between the shoulder 25 on the hub 1 and the bearing surface 38 on the door 3.

(d) Push down the key handle 94 to lower the key lever 88 and push the key member 82 radially outwards, so that the key segment 82 moves into the gap created between two of the segment blocks 30.

(e) Screw in and tighten the vent/bleeder screw 60 into the aperture 62 in the door.

With the key element 82 engaged and locked by the vent screw 60, the six large segments 30 are prevented from being extracted from the locked position because a full circle of segments 30, 82 has been created. Moreover an advantageous hoop stress is created in the complete set of locking segments 30, 82 if any contraction is experienced, thus dispersing contraction forces more efficiently. If failure of any mechanism occurs under pressure the closure will not open due to these factors.

The closure of the present invention offers a number of advantages over the prior art. In particular, once the locking members 30 are in the locking position and the key member 82 has been engaged between the locking members 30, the transfer of load from the door 3 to the hub 1 takes place over an uninterrupted circumferential contact area. The movement of the major locking elements, the segment blocks 30, is undertaken in a single rotational movement of the drive plate 101, and completion of the locking sequence requires only the integral key member 82 to be slid into position and retained via the vent screw 60. Once the key member 82 is in position the drive plate 101 is locked, and cannot be rotated.

When the key member is engaged a full circumferential hoop is created by the locking segments 30 and key segment 982. When subjected to load the hoop cannot contract for three reasons. Firstly the locking segments 30 are in compression, and due to the angled contact faces 136, 137 no lateral forces are present. Secondly a complete mechanical hoop is present. Thirdly even if any lateral force were present acting on the segments 30, hoop stresses would be created, prohibiting any contraction.

Once the key member 82 is engaged, it can be locked by the vent screw 60, which is retained on the key slider 84. The vent screw seal is visible to ensure identification of any pressure release from the vessel or pipe 2.

The locking members 30 move in three different axes of travel under a single drive plate movement: radially to move into the hub recess 23, circumferentially or tangentially to move into contact with each other, and axially towards the door 3, urged by the cam surface provided by the tapered flange 120 on the drive plate 101. The segment blocks 30 thus form the major part of the hoop, with the final element being completed by means of the key segment 82.

The key segment 82 has the same cross-sectional shape, at least in regard to the parts in contact with the hub 1 and door 3, as the segment blocks 30, to ensure uniform load transfer from the door to the hub.

The means for rotating the drive plate 101 described above, including a ratchet plate 106 and toothed gear 108, is by way of example only. Any suitable means of rotating the drive plate 101 may be used.

The means for retaining and guiding and operating the key segment 82 described above, including the key slider 84, the means of connection between the key segment 82 and the key slider 84, and the key handle 88, is by way of example only. Any suitable means of guiding and operating the key segment between an unengaged and an engaged position may be used.

The door seal 70 may be a self energising lip seal or an 0 ring seal, or any suitable seal.

Although in the illustrated embodiments the locking members 30 and key members 82, 282 are shown as segments, it is to be understood that the locking members 30 and key members 82, 282 can have shapes other than those illustrated, provided that they can fit together to form an unbroken ring in the expanded locking position.

Although the invention has been described such that in the expanded locking position there is one gap between the locking members 30 into which the key member 82 can be placed, it is to be understood that the invention encompasses a closure in which there are two or more gaps formed between the locking members 30 in the expanded position, and there are two or more key members which can be placed into the gaps.

These and other modifications and improvements can be incorporated without departing from the scope of the invention.

1. A closure comprising:
a door adapted to fit into an aperture in a member to be closed;
a plurality of arcuate locking members disposed around a periphery of the door for locking the door to said member, the locking members being constrained so as to permit movement of the locking members in at least a radial direction towards and away from the periphery of the door, each locking member having a respective guide pin associated therewith;
a key member; and
a drive member adapted to drive the locking members and including a plurality of drive slots, each drive slot engaging with the respective guide pin associated with one of said locking members;
such that rotation of the drive member relative to the door causes the locking members to move radially outwardly and at least some of the locking members to move both circumferentially and radially outwardly such that the locking members are moved from an unexpanded unlocked position to an expanded locking position in which the locking members are in mutual contact and which permits the key member to be moved to a position between two adjacent locking members.

2-3. (canceled)

4. A closure according to claim 1, wherein the drive member is mounted to the door such that rotation of the drive member relative to the door in a first locking direction causes the guide pins to move radially outwardly and at least some of the guide pins to move both circumferentially and radially outwardly such that the locking members are moved to the expanded locking position.

5. A closure according to claim 1, further comprising a hub having an aperture therein, wherein the aperture comprises a substantially cylindrical bore having a locking recess, and wherein the recess has a bearing surface adapted to seal against a corresponding bearing surface on the door and an angled wedge surface opposed to the bearing surface.

6. A closure according to claim 5, wherein the locking members are provided with a corresponding angled surface adapted to engage the angled wedge surface.

7. A closure according to claim 1, wherein each drive slot has a first arcuate portion whose radial spacing from the axis of rotation is substantially constant, and a second offset portion whose radial spacing from the axis of rotation decreases with distance from the first portion.

8. A closure according to claim 7, wherein the drive slots are each provided with first arcuate portions of different length, adapted to drive the locking members through corresponding different amounts of circumferential displacement when the locking members are moved from the unexpanded unlocked position to the expanded locking position.

9. A closure according to claim 1, wherein the door is provided with a plurality of guide slots each engaging with a respective one of said guide pins, the guide slots being arranged such that the longitudinal axis of each guide slot is at an angle of inclination to the radial direction, the angle of inclination varying according to the circumferential position of the guide slot.

10. A closure according to claim 9, wherein each locking member has two guide pins associated therewith, and each guide pin engages both a respective guide slot in the door and a respective drive slot in the drive member.

11. A closure according to claim 1, wherein the key member is slidably mounted to the door.

12. A closure according to claim 1, further comprising a lever means adapted to permit the key member to be moved radially outwardly from a first unengaged position to a second engaged position in which the key member is engaged between two locking members to form a substantially continuous ring with the locking members.

13. A closure according to claim 1, further comprising a vent plug connected to move with the key member, wherein the door is provided with a vent aperture adapted to receive the vent plug.

14. A method of locking a closure comprising a door adapted to fit into an aperture in a member to be closed, the method comprising:
rotating a drive member rotatably mounted on the door to thereby urge a plurality of arcuate locking members disposed around a periphery of the door to move radially outwards and circumferentially towards each other, each locking member having a respective pin associated therewith and the drive member having a plurality of drive slots, each drive slot engaging with the respective guide pin associated with one of said locking members, such that the locking members are moved from an unexpanded unlocked position to an expanded locking position in which the locking members are in mutual contact with a gap between two adjacent locking members; and
moving a key member into the gap between the two adjacent locking members to thereby prevent the locking members from moving radially inwards;
such that in the expanded position the locking members engage both the door and the aperture thereby preventing opening of the door.

15. A method of unlocking a closure comprising a door adapted to fit into an aperture in a member to be closed, the method comprising:
moving a key member from between two adjacent locking members of a plurality of locking members disposed around a periphery of the door to thereby permit the locking members to move radially inwards;
rotating a drive member rotatably mounted on the door to thereby urge the plurality of arcuate locking members disposed around the periphery of the door to move radially inwards and circumferentially away from each other, each locking member having a respective pin associated therewith and the drive member having a plurality of drive slots, each drive slot engaging with the respective guide pin associated with one of said locking members, such that the locking members are moved from an expanded locking position in which the locking members are in mutual contact with a gap between two adjacent locking members to an unexpanded unlocked position;
such that in moving to the unexpanded position the locking members come out of engagement between the door and the aperture thereby permitting opening of the door.
